(19) United States
(12) Patent Application Publication
(10) Pub. No.: US 2026/0233323 A1
(43) Pub. Date: Aug. 13, 2026

(54) Additively Manufactured Representative Witness Coupon Techniques

(71) Applicant: Relativity Space, Inc., Long Beach, CA (US)

(72) Inventors: Tyler Ledgett, Long Beach, CA (US); Michael Robert Hall, Long Beach, CA (US); Van Earl Bishop Wright, JR., Long Beach, CA (US)

(73) Assignee: Relativity Space, Inc., Long Beach, CA (US)

(21) Appl. No.: 19/401,219

(22) Filed: Nov. 25, 2025

Related U.S. Application Data
(60) Provisional application No. 63/757,264, filed on Feb. 11, 2025.

(51) Int. Cl. B23K 9/04; B33Y 10/00; B33Y 30/00; B33Y 80/00; G01N 17/04

(52) U.S. Cl. CPC B23K 9/04; B33Y 10/00; B33Y 30/00; B33Y 80/00; G01N 17/043

(57) ABSTRACT

Additively manufactured witness coupon devices, apparatus, and methods for their manufacture and use are provided. The witness coupons are produced using advanced additive manufacturing techniques, including but not limited to Wire Arc Additive Manufacturing (WAAM). The witness coupons are designed to be printed alongside or integrated into the build of additively manufactured parts, ensuring similar thermal and mechanical processing conditions.

### CROSS-REFERENCED APPLICATIONS

The current application claims priority to Provisional Application No. 63/757,264, filed Feb. 11, 2025, the disclosure of which is incorporated herein by reference in its entirety.

### FIELD OF THE INVENTION

Embodiments disclosed herein relate to additive manufacturing techniques, and more specifically, additive manufacturing processes for witness coupons and structures formed thereby.

### BACKGROUND

Additive manufacturing is a process by which a product or part is manufactured by adding one layer of material on top of another in a sequence or pattern that would result in a solid part being built. This method of manufacturing is commonly referred to as three dimensional or 3-D printing and can be done with different materials, including plastic and metal. There are many different processes available for implementing 3-D printing of articles, including, among others, direct energy deposition, wire arc additive manufacturing, powder bed fusion, cold spray, etc.

Wire arc additive manufacturing (WAAM) is a three-dimensional printing process in which the heat energy of an electric arc or another energy source is employed for melting a wire and depositing its material in layers according to a deposition path to form a three-dimensional structure.

A witness coupon, also referred to as a test coupon or process coupon, is a representative sample of material that undergoes the same manufacturing processes as the manufactured article or product. This coupon is often designed for the validation of, and controlling the quality of, the various production steps of the manufactured article, such as casting, forging, wrought plate rolling, coating, welding, heat treatment, and additive manufacturing techniques such as laser powder bed fusion (L-PBF). The coupon functions as a surrogate, enabling testing and monitoring of the process conditions while the final product can remain in its manufactured state. By employing such coupons, manufacturers can effectively assess production quality without compromising the usability of the end product.

Challenges persist in manufacturing witness coupons that accurately represent the WAAM process due to its inherent process differences from traditional (wrought) and other additive manufacturing techniques (PBF).

### SUMMARY OF THE INVENTION

The elements of this disclosure pertain to additive manufacturing methods and processes, associated additively manufactured witness coupons, and the resultant structures and their properties produced through these methods.

In some embodiments, the techniques described herein relate to a method of additively manufacturing a witness coupon, the method including: determining a build volume of a witness coupon; determining an orientation of the witness coupon to replicate a property of a part; preparing a build plate for additive manufacturing the witness coupon; securing a fixture to an additive manufacturing system; electrically coupling and grounding the fixture and the additive manufacturing system; depositing a first layer of a material on the build plate; depositing a layer of the material on the part; depositing additional sequential layers of the material on the first layer of a material on the build plate forming the witness coupon; manufacturing the witness coupon concurrently layer by layer with the part; wherein the sequential layers are configured to be representative of at least one property of the concurrently manufactured part.

In some embodiments, the techniques described herein relate to a method further including, post-processing the witness coupon to match post-processing conditions of the part.

In some embodiments, the techniques described herein relate to a method further including, extracting at least one test sample from the witness coupon.

In some embodiments, the techniques described herein relate to a method further including, subjecting the at least one test sample to a quality assurance test selected from the group consisting of non-destructive evaluation, destructive testing, statistical analysis to validate the additive manufacturing process.

In some embodiments, the techniques described herein relate to a method wherein, the build volume of the witness coupon is configured for a testing standard.

In some embodiments, the techniques described herein relate to a method wherein, wherein the at least one property is selected from the group consisting of grain structure and stress orientations.

In some embodiments, the techniques described herein relate to a method wherein, depositing the first layer of the material onto the build plate forms an interaction zone of the coupons and an interface between the witness coupon and the build plate.

In some embodiments, the techniques described herein relate to a method wherein, the additional sequential layers are deposited with a process parameter representative of the part the process parameter is selected from the group consisting of heat input, deposition rate, and cooling.

In some embodiments, the techniques described herein relate to an apparatus for additively manufacturing a witness coupon, the apparatus including: a fixture secured to an additive manufacturing system, the fixture being electrically coupled and grounded to the additive manufacturing system; wherein the fixture includes a build plate configured to support the deposition of a material for a witness coupon; a material deposition system configured to deposit a first layer of the material onto the build plate and additional sequential layers of the material onto the first layer; wherein the material deposition system sequentially print layers of the coupon and the part and is configured so that the layers of the coupon are representative of a property of the part; and wherein the witness coupon and the part are manufactured concurrently.

In some embodiments, the techniques described herein relate to an apparatus wherein, the property of the part is selected from the group consisting of heat input, deposition rate, cooling, grain structure and stress orientations.

In some embodiments, the techniques described herein relate to an apparatus wherein, an orientation of the witness coupon is optimized for printing and configured to replicate properties of a concurrently printed part.

In some embodiments, the techniques described herein relate to an apparatus wherein, the witness coupon is disposed at an electrical extremity from a grounding point.

In some embodiments, the techniques described herein relate to an apparatus wherein, the fixture is configured so that the witness coupon is located proximal to the part.

In some embodiments, the techniques described herein relate to an apparatus wherein, the fixture location is further configured to decrease a distance between the part and the coupon.

In some embodiments, the techniques described herein relate to a method of additively manufacturing a witness coupon, the method including: mounting a part to a build plate of an additive manufacturing system, wherein the part is mechanically coupled to the build plate and electrically coupled to the build plate; mounting a coupon fixture to the part, wherein the coupon fixture is mechanically coupled to the part and electrically coupled to the part; depositing, by the additive manufacturing system, a layer of a feature on the part by melting a material onto the part using an electrical current flowing through the material, the part, and the build plate; and depositing, by the additive manufacturing system, a layer of a witness coupon on the coupon fixture by melting the material onto the coupon fixture using an electrical current flowing through the material, the coupon fixture, the part, and the build plate.

In some embodiments, the techniques described herein relate to a method, further including repeating the steps of the depositing the layer of the feature and of the depositing the layer of the witness coupon until the feature has been additively manufactured and the witness coupon has been additively manufactured.

In some embodiments, the techniques described herein relate to a method, further including cooling the witness coupon on the coupon fixture by cooling the coupon fixture using coolant flowing through the coupon fixture, the part, and the build plate.

In some embodiments, the techniques described herein relate to a method, further including: mounting a second coupon fixture to the build plate, wherein the second coupon fixture is mechanically coupled to the build plate and electrically coupled to the build plate; and depositing, by the additive manufacturing system, a layer of a second witness coupon on the second coupon fixture by melting the material onto the second coupon fixture using an electrical current flowing through the material, the second coupon fixture, and the build plate.

In some embodiments, the techniques described herein relate to a method, further including: mounting a second coupon fixture to an external support, wherein the second coupon fixture is mechanically coupled to the external support; and depositing, by the additive manufacturing system, a layer of a second witness coupon on the second coupon fixture by melting the material onto the second coupon fixture using an electrical current flowing through the material and the second coupon fixture.

In some embodiments, the techniques described herein relate to a method, further including: depositing, by the additive manufacturing system, a layer of a second witness coupon on the build plate by melting the material onto the build plate using an electrical current flowing through the material and the build plate.

Additional embodiments and features are set forth in component in the description that follows, and in component will become apparent to those skilled in the art upon examination of the specification or may be learned by the practice of the disclosure. A further understanding of the nature and advantages of the present disclosure may be realized by reference to the remaining portions of the specification and the drawings, which forms a component of this disclosure.

### BRIEF DESCRIPTION OF THE DRAWINGS

The description will be more fully understood with reference to the following figures and data graphs, which include various embodiments of the disclosure and should not be construed as a complete recitation of the scope of the disclosure, wherein:

FIG. 1 shows a schematic of the ASTM E8 standard.

FIG. 2 shows a schematic of a witness coupon additively manufactured in accordance with some embodiments of the disclosure.

FIG. 3 shows a cross-section of a witness coupon additively manufactured on a build plate in accordance with some embodiments of the disclosure.

FIG. 4A shows a schematic of an additive manufacturing apparatus in accordance with some embodiments of the disclosure.

FIG. 4B shows an additive manufacturing apparatus in accordance with some embodiments of the disclosure.

FIGS. 5A and 5B show example witness coupon fixtures in accordance with some embodiments of the disclosure.

FIGS. 6 and 7 depict flow charts for methods of additively manufacturing witness coupons in accordance with some embodiments of the disclosure.

FIG. 8 depicts a flow chart for a method of path planning to additively manufacture a witness coupon and features in accordance with some embodiments of the disclosure.

### DETAILED DESCRIPTION

It will be understood that the components of the embodiments, as generally described herein and illustrated in the appended figures, may be arranged and designed in a variety of different configurations. Thus, the following more detailed description of various embodiments, as represented in the figures, is not intended to limit the scope of the present disclosure but is merely representative of various embodiments. While various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment. Thus, the phrases “in one embodiment”, “in an embodiment”, and similar language throughout this specification may, but do not necessarily, all refer to the same embodiment.

### Witness Coupons

A witness coupon is a representative sample of material that undergoes manufacturing processes the same as, or at least similar to, the final article that it “witnesses.” The witness coupon can function as a surrogate to the final article so that the manufacturing process can be validated and monitored while limiting, or avoiding altogether, the need for costly, time, and resource-consuming destructive testing of the final article. Utilizing witness coupons can improve quality control by monitoring and validating various production steps of the manufactured article, such as casting, forging, wrought plate rolling, coating, welding, heat treatment, and additive manufacturing without damaging the final product. As a result, witness coupons are indispensable for manufacturing and quality control in many industries.

Examples of use cases for witness coupons include welding, where a coupon welded alongside pipeline joints is tested for cracks or porosity; coatings, where a coupon coated with the same material as automotive parts is checked for thickness and corrosion resistance; and additive manufacturing, where 3-D-printed coupons are tested to verify mechanical properties like strength and ductility.

Witness coupons allow for non-destructive part and process quality assurance by enabling destructive testing to verify process quality without sacrificing the actual product, such as tests for tensile strength, hardness, and coatings that damage, destroy, or otherwise modify the coupon instead of the product. For example, an aerospace component or medical implant often cannot be cut or stressed during testing without damaging the article. In many such cases, witness coupons provide a safe alternative. The witness coupon can be utilized to confirm that critical parameters were correctly applied and processed, such as temperature, heat treatment, pressure, and duration, as well as environmental conditions in the manufacturing environment or the process parameters themselves used to manufacture a product. For example, if a heat-treatment coupon shows improper hardness, the batch or article for which it is standing can be further investigated before defective parts reach customers. Additionally testing coupons reduce waste and costs that would be associated with testing and scrapping high-value products. The witness coupon can be representative of an entire batch, saving time and resources. Furthermore, many industries, such as automotive, aerospace, and medical devices, require coupons as part of many of their regulatory standards, such as NASA and ISO standards or ASTM test procedures.

In many applications, witness coupon testing can provide records and auditable proof that the production processes meet the requisite specifications. As such, the witness coupon test data over the course of a production run or production campaign can be compared against other historical production runs, providing a historical record of process stability and how any individual run or campaign aligns with the statistics. Furthermore, deviations in the witness coupon test results can be used to flag potential issues such as equipment wear, material deviations, and changes in the operator's procedures. In addition, if a product fails or an incident occurs where a product may have been the cause, witness coupons from the same batch can be analyzed to help determine whether the product was the root cause and, if so, whether a material defect, a process error, environmental or other factor are to blame. For safety-critical applications, where the failure of components can lead to severe injury or loss of life, such as in nuclear reactors and aerospace components like aircraft and rocket engines, witness coupons often play a crucial role in ensuring that strict quality standards are upheld and prevent catastrophic failures.

Coupons are often standardized in size and shape to ensure consistent testing. They are labeled with batch numbers, dates, and process details, enabling traceability back to specific production runs. By acting as a “witness” to the manufacturing process, these coupons ensure quality, reduce risks, and uphold trust in high-stakes industries.

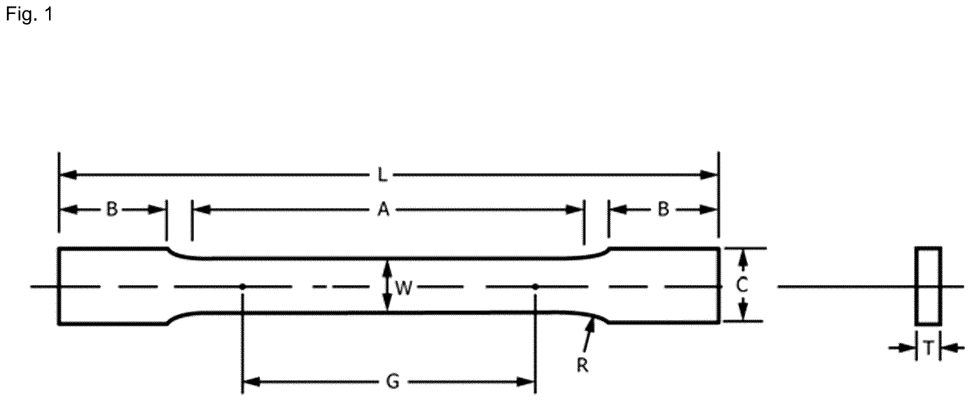

The ASTM E8/E8M (E8) standard is one of the standards most often utilized for testing metallic materials. The E8 standard outlines procedures for accurately determining key mechanical properties such as yield strength, tensile strength, elongation, and reduction of area. A key aspect of the standard is the meticulous preparation of the test specimens. The test specimens are produced from the same material batch and subjected to identical processing conditions as the final component, such as from a witness coupon manufactured alongside the manufactured component, ensuring that the test results accurately reflect the component material's performance in its real-world applications. Additionally, the E8 standard specifies precise dimensions for specimens; as shown in FIG. 1. Attention to surface finish is also essential, as any irregularities can lead to stress concentrations that might adversely affect the test outcomes.

The E8 testing procedures stipulate stringent test parameters, which are vital for obtaining reliable yield and tensile strength measurements. The E8 procedures facilitate rigorous quality control, certification, and failure analysis by providing comprehensive test reports that document all critical material properties. In safety-critical industries such as aerospace and nuclear energy, adherence to the ASTM E8/E8M standard is considered indispensable for ensuring that materials can withstand operational stresses and perform reliably under extreme conditions. By maintaining compliance with E8 standardized testing methods, manufacturers can ensure that their components consistently meet design specifications and regulatory requirements.

### Additive Manufacturing

Additive manufacturing is the process of creating an object by building one layer at a time. This process can be contrasted with conventional molding or casting techniques, in which components of an object are created in a single step via a premade mold of the object and then assembled together. When manufacturing complex devices, additive manufacturing has the distinct benefit of being able to produce many geometries using a variety of materials, thereby permitting the integration of many previously distinct components into a single integral piece. By contrast, conventional manufacturing typically requires the formation of numerous components from stock material such as plate which then must be assembled to form a whole via joining techniques. Additive manufacturing eliminates that joining barrier, consolidating parts, deleting manufacturing steps, and unlocking new designs. This also means that manufacturers can eliminate weight from an object. This is particularly important in industries where weight can affect the functionality of a final product such as in the aerospace industry. However, additive manufacturing presents challenges in ensuring that the final part possesses sufficient engineering properties for its intended application.

Additive manufacturing is a genus term that encompasses numerous different techniques; binder jetting (BJT), cold spray additive manufacturing (CS), directed energy deposition (DED), wire arc additive manufacturing (WAAM), directed energy deposition-arc (DED-arc), material extrusion, and powder bed fusion (PBF) are some of the more frequently utilized additive manufacturing methods. Each additive manufacturing method presents its own strengths, weaknesses, and challenges and many of the techniques comprise further sub-techniques that address them. For example, PBF encompasses a variety of techniques including direct metal laser melting (DMLM), direct metal laser sintering (DMLS), electron beam melting (EBM), selective laser sintering (SLS) and selective heat sintering (SHS)), and sheet lamination, including laminated object manufacturing (LOM) and ultrasonic additive manufacturing (UAM), among others. Each of these species of the additive manufacturing genus has different capabilities in such as material limitations, overall part size attainable, and individual feature size available.

Additive manufacturing has rapidly gained adoption in numerous industries due to its flexibility and process capabilities. PBF is one of the most common metal-based methods where a powder bed is deposited in layers between 20μm and 100μm thick and melted most often with an electron beam or laser locally. The PBF method is commonly adopted for the production of small-scale parts up to hundreds of millimeters wide. However, large industrial-scale components are often impractical to fabricate using PBF.

In a PBF additive manufacturing process, the manufacturing process is conducted by depositing powder layer by layer on a flat build plate, which allows for witness coupons to be printed alongside the actual parts in the same printer volume and consequently in functionally identical conditions and with the same material. In contrast, within a large WAAM print, different regions within the same “layer” will exhibit different material properties. In other words, the number of variables that can change per unit of time, distance, or “layer” during a WAAM operation is significantly greater than the number of variables that can change in a method like PBF. WAAM parts often experience uneven thermal cycles as layers cool at different rates, and a coupon printed separately would not inherently replicate the thermal conditions of the actual part, which could lead to nonrepresentative test results. Additionally, WAAM is often used for large-scale components that can be several meters in size and the witness coupons are often significantly smaller than the parts they are representative of. Simply scaling down the coupon's geometry may not capture bulk effects such as residual stress distribution. As a result, manufacturing suitably representative coupons for WAAM is more complex than for conventional manufacturing or powder-based additive manufacturing due to the process's unique characteristics.

### Additive Manufactured Witness Coupon Aspects

Although the following discussion will focus on the use of WAAM techniques for aerospace applications generally and rocket engine parts and components more specifically, it will be understood that many such techniques could be used in accordance with the aspects and embodiments described herein. WAAM uses an arc to melt metal wire, depositing layers to build large, complex components such as aerospace parts and ship propellers. However, the WAAM process introduces unique challenges, such as thermal gradients, residual stresses, and anisotropy. Witness coupons help analyze and address these WAAM manufacturing challenges but require careful design and testing.

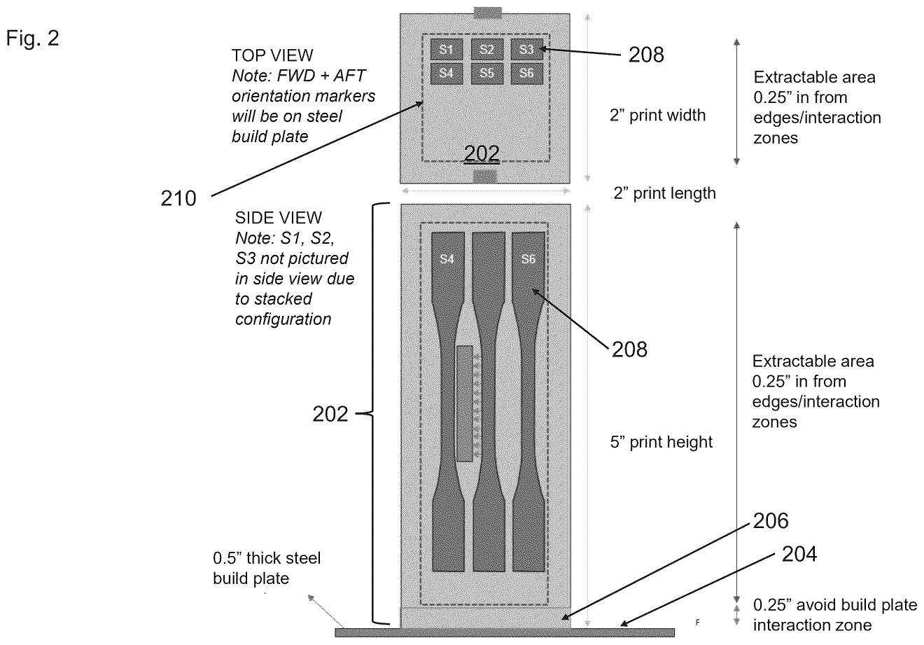

Aspects of the disclosure provide for additively manufactured witness coupons, manufacturing methods for their production, and associated devices and apparatus thereto. In various aspects, additive manufacturing witness coupons may utilize a variety of additive manufacturing processes, including but not limited to WAAM, to produce witness coupons alongside additively manufactured parts with varying dimensional requirements. FIG. 2 shows a schematic of a witness coupon 202 additively manufactured on a build plate 204 in accordance with some embodiments. The coupon 202 is built up the build plate 204 by depositing a first layer plate 204 forming an interaction zone 206 of the witness coupon 202. Additional layers are subsequently deposited, in conjunction with layers building deposited for a part that the witness coupon is representative of. Once the final layer of the part and coupon is deposited, test samples 208 can be manufactured from an interior volume 210 of the witness coupon 202 which is representative of the manufactured part. The schematic shows an example witness coupon with a 5″×5″×2″ build volume built in a vertical configuration for the production of six test samples; however, the build volume and orientation can be configured in accordance with many embodiments for any number of test samples and orientations. In many embodiments, the witness coupon orientation and volume are configured for manufacturing samples for standards and testing procedures that would be known to one of skill in the art.

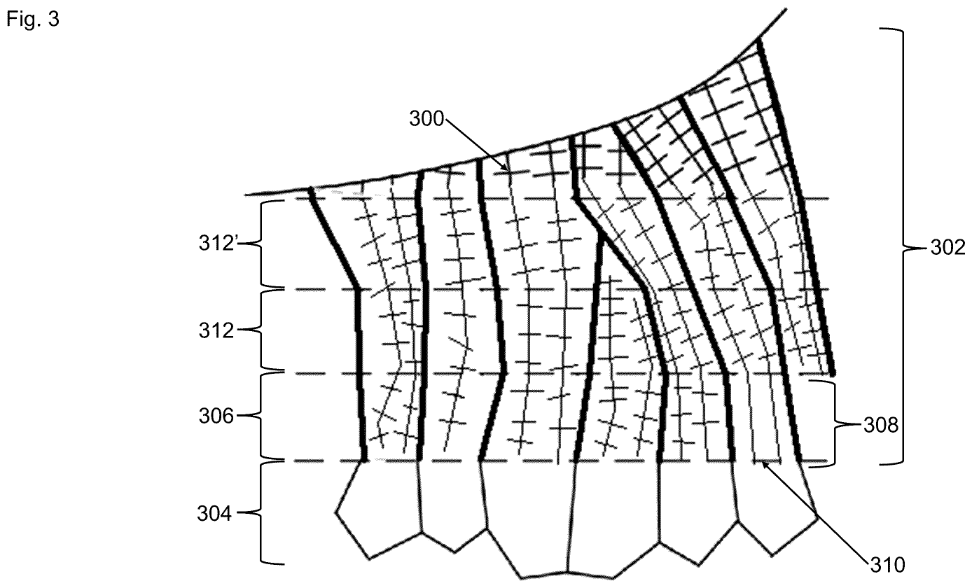

In metal additive manufacturing, witness coupons can play a critical role in validating process parameters, material properties, and structural integrity. In many embodiments, additive manufacturing methods may be employed to produce witness coupons with variant dimensional and structural requirements. In many embodiments, additive manufacturing witness coupons can enable the replication of specific properties of a part sequentially or concurrently manufactured. In many such embodiments, material properties such as grain structures and stress orientations present in a final part can be replicated in a witness coupon. FIG. 3 shows grain structures 300 of a cross-section of an example witness coupon 302 additively manufactured on a build plate 304 in accordance with some embodiments. The coupon 302 is built upon a build plate 304 by depositing a first layer 306 on the build plate 304 which forms an interaction zone 308 between the witness coupon 302 and the build plate 304 at starting at the material interface 310. Additional layers 312 and 312′ are subsequently deposited in conjunction with layers deposited for the part that the witness coupon is representative of.

In accordance with many embodiments, witness coupon 302 can be utilized for quality assurance. In many such embodiments, the witness coupon 302 and samples made from the coupon 208 can be subjected to various testing procedures, such as mechanical testing, destructive testing, and nondestructive testing.

In numerous embodiments, the witness coupons and the testing of the witness coupons are utilized for manufacturing process validation. Manufacturing witness coupons in accordance with many embodiments enables the production of statistical data for process validation. In many such embodiments, the data can be utilized to build a database of statistical records. In many embodiments, witness coupon data can be utilized to monitor and validate the weld system functionality. In many embodiments, witness coupon data can be utilized to monitor and validate wire consistency and performance. In many embodiments, witness coupon data can be utilized to monitor and validate environmental fluctuations. In many embodiments, witness coupon data can be utilized to monitor and validate equipment issues such as robot wear and fatigue. In many embodiments, witness coupon data can be utilized to monitor and validate welding process parameters such as pass speed, pass weaving, wire feed speed, arc current, and travel speed. In many embodiments, witness coupon data can be utilized to monitor and validate discrepancies and variations between different production cells. In many embodiments, witness coupon data can be utilized to monitor and validate process drift over time. In accordance with numerous embodiments, witness coupon test data can be captured to meet stringent standards, process validation, and statistical requirements for high-stakes applications such as aerospace and manned space flight. In many such embodiments, the data can be used to ensure compliance with compliance standards such as NASA-6030—Additive Manufacturing Requirements for Spaceflight Systems.

Manufacturing witness coupons in accordance with numerous embodiments can provide a framework for building statistical databases to monitor process consistency and validate part quality across multiple builds. Manufacturing witness coupons, in accordance with numerous embodiments, can provide a framework to monitor process consistency across changing manufacturing variables, such as across production cells and material stock, material changes, operators, operator and shift changes, equipment changes, equipment run time, and environmental factors.

### Wire Arc Additive Manufacturing

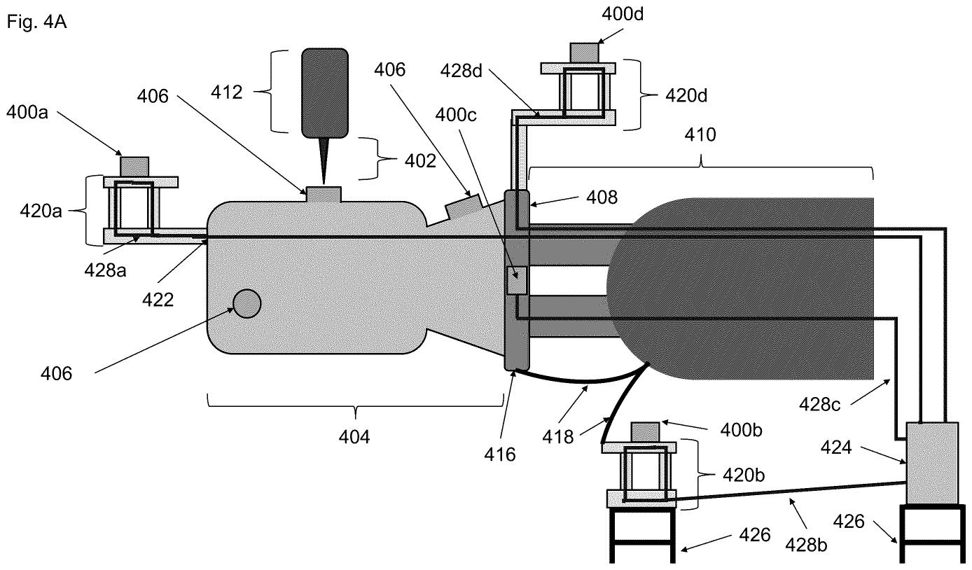

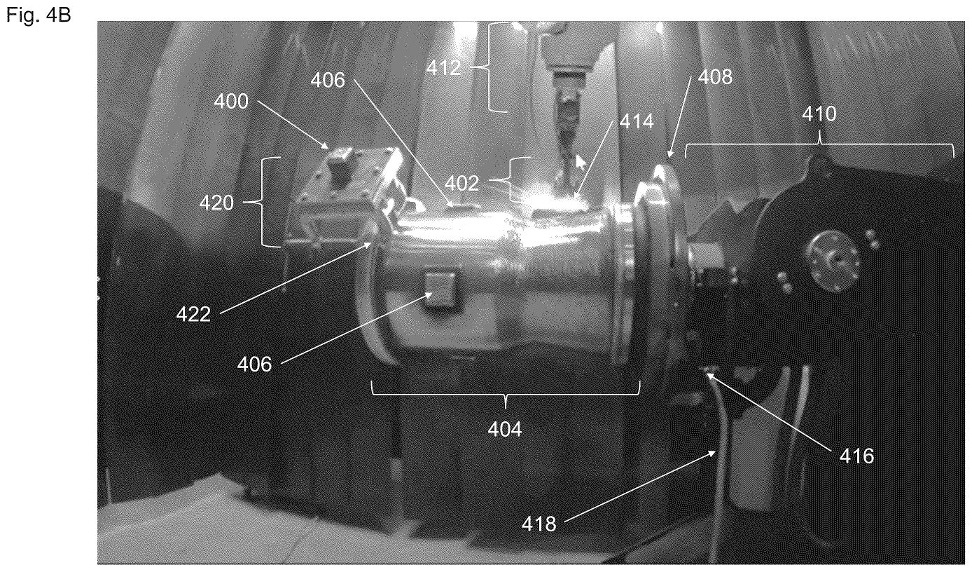

In many embodiments, a part representative witness coupon can be manufactured in a continuous additive manufacturing processes, such as WAAM. FIG. 4A schematically illustrates witness coupons manufactured in a continuous additive manufacturing process. FIG. 4B illustrates an example of a witness coupon manufactured in a continuous WAAM process. WAAM employs arc welding equipment 402 to build large near-net-shaped part 404, including its features 406, and efficiently manufacture structural components with modest complexity. In many embodiments, prior to the printing of features 406, the previously-printed part 404 is mounted upon a build plate 408 itself upon a part fixture 410. In many embodiments, the part fixture 410 is able to manipulate the part along at least one part axis. In many embodiments, manipulation is performed by a computer numerically controlled (CNC) system. In many embodiments, the arc welding equipment 402 is mounted upon an equipment manipulation device 412, such as a robot arm. In many such embodiments, the equipment manipulation device 412 is configured to manipulate the arc welding equipment 402 along at least one axis. In many embodiments, the equipment manipulation device 412 manipulations are controlled by a CNC system.

In many embodiments energy of an electric arc 414 or another energy source is employed melting a wire and depositing material layers according to a deposition path to form three-dimensional structures such as features 406 and one or more of witness coupons 400. In many embodiments, grounding is critical for maintaining a stable electric arc 414. The part 404 is electrically coupled to at least one grounding point 416. In many embodiments, the grounding point 416 is electrically coupled with a grounding wire 418 to the ground, such as the negative terminal of the power supply, while the welding torch 402 is connected to the positive terminal. In many embodiments, poor grounding can cause an unstable arc 414. In many such embodiments, inconsistent grounding can cause arc instability, leading to uneven deposition, defects, or incomplete fusion between layers. In many embodiments, improper grounding can lead to heat distribution issues. In many such embodiments improper grounding may result in uneven heat distribution, causing warping, residual stresses, or distortion in the part. In many embodiments, inadequate grounding can introduce electrical noise, affecting the precision of the deposition process and the quality of the final part 404.

FIG. 4A shows part-representative witness coupons 400a, 400b, 400c, and 400d, each of which may be part-representative to a different degree. In various embodiments, any one or more of these four coupons 400a, 400b, 400c, and 400d may be printed with part 404. FIG. 4A also shows several coupon fixtures 420, including fixture 420a coupled to part 404 and configured so that witness coupon 400a is at the extremity of the electrical path. In many embodiments, the coupon fixture 420a is coupled to the part 404 at a coupling point 422 distal to the grounding point 416. Witness coupon 400b can be printed on a separate coupon fixture 420b not coupled to part 404. In many embodiments, the coupon fixture 420b is electrically coupled with the part 404 and the grounding point 216. Witness coupon 400b can be placed near part 404 on an external support 426, such as a pedestal, cart, or shelf. Witness coupon 400c is printed directly on the build plate 408 without a coupon fixture. Witness coupon 400c is electrically coupled with the build plate 408 and the grounding point 416. Witness coupon 400d is printed on a coupon fixture 420d coupled directly to the build plate 408. Witness coupon 400d can be electrically coupled to the build plate 408 and grounding point 416 by electrically coupling coupon fixture 420d to the build plate 408.

In many embodiments, the witness coupons 400 are configured to be representative of conditions that are less ideal than conditions in various areas of part 404, such as features 406. In many such embodiments, the conditions at the extremity of the electrical path result in worse properties, such as an increase in porosity. In embodiments, multiple fixtures 420 are coupled directly to the part, to other aspects of the environment, or a combination of both. To give some examples, in one embodiment a pair of fixtures 420a (although only one is depicted on FIG. 4A) may be directly coupled to two different areas of the part, in another embodiment a pair of fixtures 420b (although only one is depicted on FIG. 4A) may be coupled to two different external supports, while in yet another embodiment a pair of fixtures 420d (although only one is depicted on FIG. 4A) may be coupled to two different areas of the build plate 408; similarly in another embodiment a pair of coupons 400c (although only one is depicted on FIG. 4A) may be printed on two different areas of the build plate 408. In many such embodiments, each fixture 420 and/or coupon 400 is configured to capture a better condition or worse condition than the manufactured part 404 such that a comparison of the resulting witness coupons 400 would be representative of a range that encompasses the conditions experienced by the part. In many embodiments, the coupon fixtures 420 are configured so there is clearance between the coupon fixtures 420 and welding head 402 so that the coupon fixtures 420 do not impede the welding head 402 during manufacturing.

In some embodiments, the temperature of the coupon fixture and/or witness coupon can be adjusted. During a manufacturing process, the part can have a different temperature than the fixture, resulting in a temperature differential between the features and the witness coupon. The part can have a larger mass than the fixture causing the part to cool features at a different rate than the witness coupon on the coupon fixture. The different temperature of the features and the coupons can result in changes in porosity or other characteristics of the material such that the witness coupon is less representative of the features. The material being printed can have a temperature limit, that when violated can lead to printed material failure. Thus, incorporating a heating and/or cooling apparatus can enable materials to be printed with an adequately-representative witness coupon in accordance with various embodiments.

In many embodiments, a cooling apparatus 424 comprising one or more cooling apparatus channels 428a, 428b, 428c, 428d can be incorporated into additive manufacturing systems to cool the witness coupons 400 to mimic the temperature of the features 406. In other words, the cooling apparatus 424 can ensure that the coupon fixture 420 exhibits representative thermal exchange for the witness coupon 400, as the part 404 exhibits for the features 406. The cooling apparatus 424 can be configured to modify the temperature of the fixture 420 to correspond to the temperature of the part 404. The cooling apparatus 424 can be connected to the coupon 420 and/or coupon fixture 420 via one or more channels 428a, 428b, 428c, 428d. The cooling apparatus channels 428a, 428b, 428c, and 428d can be adjacent to the feature, coupon, and/or part being additively manufactured to promote thermal exchange between the feature, coupon, and/or part and the cooling apparatus. In some embodiments, the cooling apparatus channel 428a is connected to the cooling apparatus 424 and run through part 404 to cool the part. The cooling apparatus 428a can be configured to connect to the part 404 to provide temperature regulation of the part 404. In certain embodiments, the witness coupon 400b and/or coupon fixture 420b is not physically attached to part 404, but mounted on an external support 426, such as a pedestal. The cooling apparatus 424 can be connected to the coupon fixture 420b via a direct cooling apparatus channel 428b. In some embodiments, the cooling apparatus channel 428c can be connected and/or adjacent to part fixture 410 and build plate 408 to cool the part fixture 410 and build plate 408. As the part 404 heats, the thermal load from the part 404 can be transferred to the build plate 408 and/or part fixture 410. The increase in thermal load on the build plate 408 and/or part fixture 410 can impart material wear and/or stress. For example, the increased thermal load can put wear and/or stress on the connections between the part 404, build plate 408, and/or part fixture 410. In some embodiments, wear on the connections can result in slip in the system and reduce the accuracy of the print orientations. In many embodiments, the connections comprise bearings and lubricants sensitive to temperature.

In some embodiments, separate cooling apparatuses can be incorporated within the system. For example, the witness coupon may not be in connection with the part such that a witness coupon cooling apparatus would be configured to cool the fixture but not the part. In certain embodiments, a part fixture cooling apparatus can be included in the part fixture and a separate witness coupon cooling apparatus can be included in a part-attached fixture. In many embodiments, the coupon fixture can be at least partially hollow such that the cooling apparatus and/or cooling apparatus channels can be encased within the coupon fixture. In some embodiments, the part comprises one or more channels such that the cooling apparatus channels can be disposed within the part. The channels in the part may remain in the part after manufacturing is complete; for example, for later use as cooling channels during part operation. Alternatively, the channels in the part may be solely for the purpose of cooling during manufacturing, and may thus remain unused during part operation, or even machined away prior to part operation. The cooling apparatus can be attached to the part and/or fixture such that the cooling apparatus is adjacent to the part and/or fixture. A cooling apparatus can be a rotary union cooling system, a water cooling system, and/or any cooling system. Though labeled a cooling apparatus, it should be understood the cooling apparatus can be configured to provide temperature adjustment to cool and/or heat the system based on the materials and/or application.

In accordance with many embodiments, witness coupon manufacturing is integrated into an additive manufacturing print path. In many embodiments, the manufacturing process is configured to form a witness coupon with an orientation optimized for printing and to replicate the properties of a concurrently printed part. In accordance with many embodiments, coupons printed with excessive heat input may show porosity or cracking, prompting parameter adjustments. In some embodiments, coupons are printed in different orientations to test tensile strength, fatigue resistance, and ductility. In accordance with many embodiments, coupons manufactured in different orientations can exhibit different properties. For example, a vertical coupon may show weaker interlayer bonding compared to a horizontal one. In many embodiments, the coupon orientation is configured to highlight potential failure points in the part.

In many embodiments, the path planning, inserts layers of a witness coupon into a sequence of layers for the part. In many embodiments, the path plan for a print includes layers of the part as well as layers of the witness coupon. Layers for the witness coupon are inserted by interleaving them. In many such embodiments, a first layer of the part is printed and a first layer of the coupon is printed, then a subsequent layer of the part and a subsequent coupon layer is printed. In many such embodiments, the layer interweave is repeated for each sequential layer. In many embodiments interleaving produces greater representativeness of the coupon. In some embodiments, the interleaving can be replaced by appending such as printing the coupon entirely last. In some such embodiments the coupon is appended so that other factors and material properties can be represented in the coupon.

In many embodiments, the witness coupon and the part are configured to be close to each other, physically. In some embodiments, the coupon and the part are configured to be close to each other electrically. In many embodiments, the coupon and the part are configured to be close to each other by mounting an electrically conductive fixture to the part upon which the coupon is printed. In many embodiments, the part and the coupon share an electrical ground. In many such embodiments, sharing an electrical ground increases the representativeness of the coupon and the part. In many embodiments, physical proximity and shared space increases the print speed. In many such embodiments, the print head travels a shorter distance between the part and the coupon. In some embodiments, the fixture thermally isolates the witness coupon from the part. In some such embodiments, the thermal distance is configured for the thermal management of the part.

In many embodiments, the orientation of the witness coupon, the fixture, or both are configured in an orientation and direction with respect to the part such as horizontal or vertical. In many embodiments, the sizing the coupon, the fixture platform, or both, are configured in a ratio to the part. In many embodiments, the part, coupon, and fixture are configured in alternate orientations and sizes, alternate layer deposition schemes, and travel times and delays as would be known to one skilled to enhance the representativeness of the resulting witness coupon.

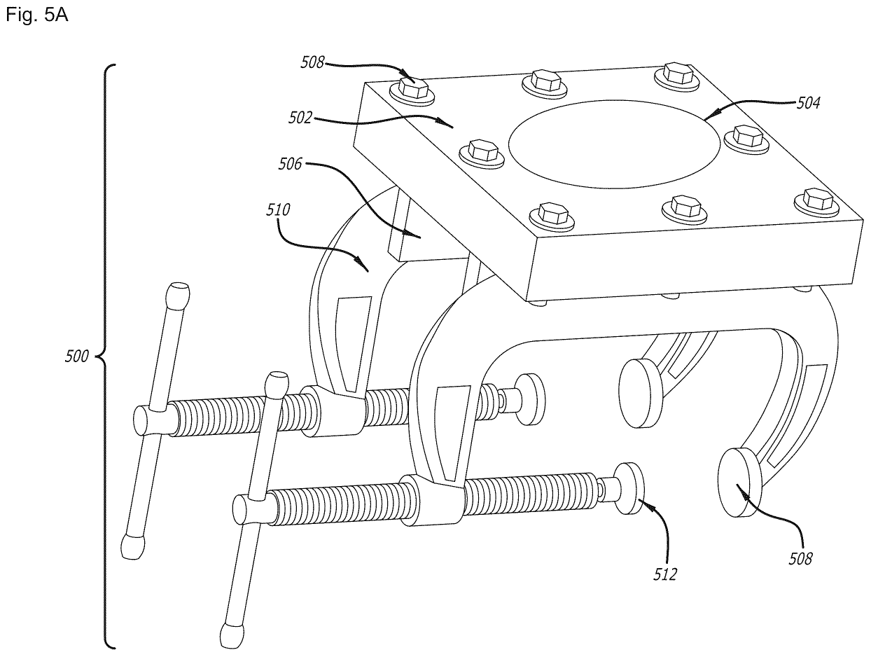

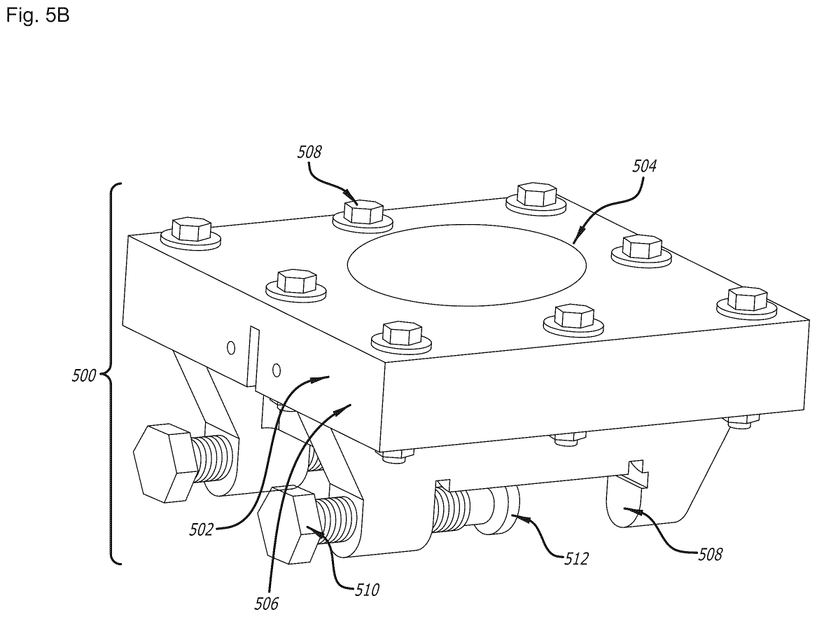

FIG. 5A and FIG. 5B show example witness coupon fixtures. In many embodiments, the witness coupon fixture 500 has a build plate 502 upon which the witness coupon is deposited in build area 504. In many embodiments, the build plate 502 is coupled to a fixture structure 506. In some embodiments, the build plate 502 is coupled to the structure 506 with a plurality of fasteners 508 such as bolts. In many embodiments, the build plate 502 is configured to be decoupled from the structure 506 so that the build plate 502 can be rapidly replaced and the coupon removed. In many embodiments, the structure 506 is configured with a coupling point 508. In many embodiments, the coupling point 508 is configured to electrically couple the fixture 500 to a part. In some embodiments, the coupling point 508 is configured to thermally couple the fixture 500 to a part. In some embodiments, the coupling point 508 is configured to thermally isolate the fixture 500 from a part. In many embodiments, a clamping device 510 is disposed on the structure 506. In many such embodiments, the clamping device 510 is configured with a clamping point 512 such that when the clamping device 510 is actuated the clamping point 512 can apply a force to a part disposed between the clamping point 512 and the coupling point 508 securing and coupling the fixture 500 to the part.

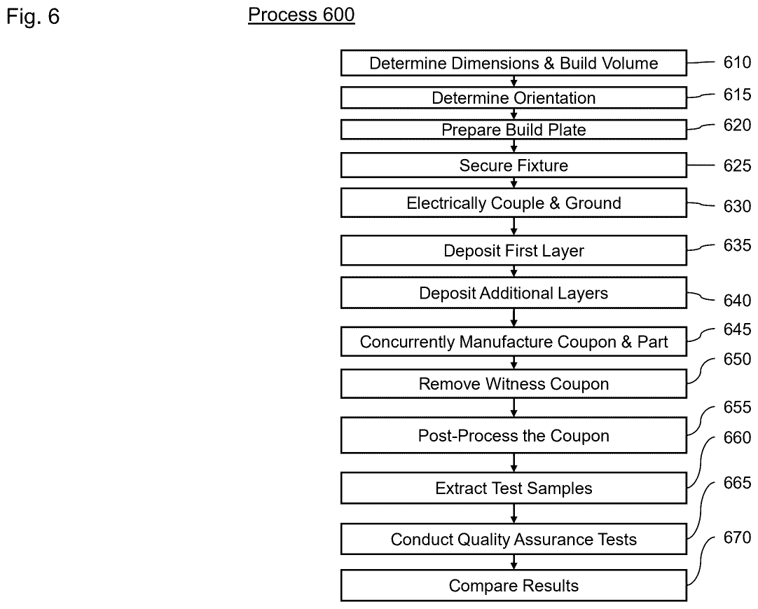

FIG. 6 depicts process 600 of additively manufacturing witness coupons. At step 610, the dimensions and build volume of the witness coupon are determined based on the testing standard and requirements of the part it represents. At step 615, the orientation of the coupon (e.g., vertical or horizontal) to replicate the part's properties, such as grain structure and stress orientations, are determined. At step 620, the build plate upon which the witness coupon is to be manufactured is prepared for the additive manufacturing process. At step 625, the fixture is secured to the additive manufacturing system, either by securing it to a previously-printed part on a build plate or by securing it to the build plate directly. At step 630, the fixture and additive manufacturing system are electrically coupled and ground. At step 635, a first layer of material is deposited onto the build plate, forming the interaction zone and interface between the witness coupon and the build plate. At step 640, additional sequential layers of material are deposited, representative of the process parameters of the part, or part features, the coupon represents such as, heat input, deposition rate, and cooling. At step 645, the coupon is concurrently manufactured layer by layers with the part it replicates. At step 650, the witness coupon is removed from the fixture. At step 655, the witness coupon is post-processed to match the part's post-processing conditions such as heat treatment. At step 660, test samples are extracted from the witness coupon. At step 665, the test samples are subjected to quality assurance test such as NDE and destructive testing. At step 670, results from the witness coupon are compared to with the expected properties of the part and to validate the additive manufacturing process and ensure the part meets required specifications.

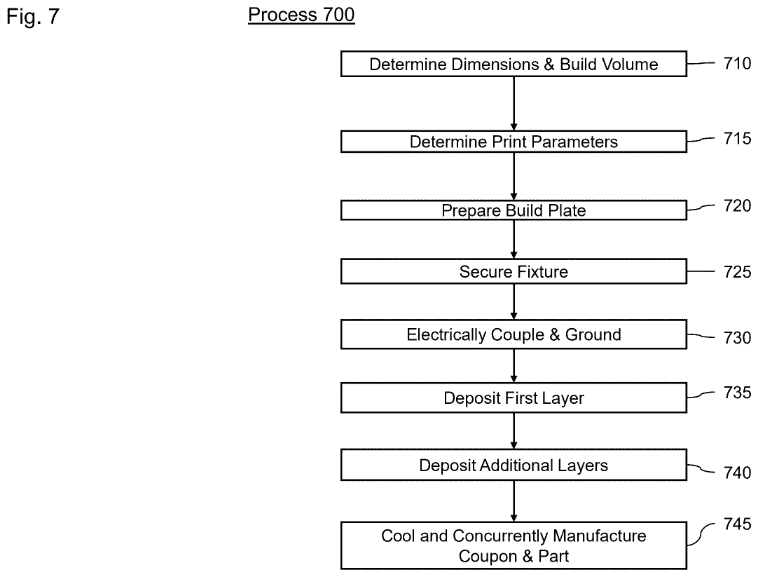

FIG. 7 depicts process 700 of printing a witness coupon incorporating a cooling apparatus. At step 710, the dimensions and build volume of the witness coupon are determined based on the testing standard and requirements of the part it represents. At step 715, the print parameters of the coupon are determined to replicate the part's properties, such as grain structure, stress orientations, and/or material failure temperature. The additive manufacturing system can incorporate a cooling apparatus such that the temperature of the witness coupon is reduced, such as by regulating it to mimic the temperature of the features being printed. At step 720, the build plate upon which the witness coupon is to be manufactured is prepared for the additive manufacturing process. At step 725, the fixture is secured to the additive manufacturing system, either by securing it to a previously-printed part on a build plate, to the build plate directly, or to external supports. In embodiments where the witness coupon is printed directly on the same build plate as the part, step 725 may be omitted. In some embodiments, the build plate for the witness coupon is separated from the part and/or part build plate. At step 730, the fixture and additive manufacturing system are electrically coupled and ground. In many embodiments, the fixture and additive manufacturing system are electrically coupled and grounded by electrically coupling the fixture to the part. In certain embodiments, the fixture and additive manufacturing system are electrically coupled and grounded by electrically coupling the separate fixture to the ground point of the part. In various embodiments, the build plate of the witness coupon is attached to the build plate of the part such that the witness coupon and the part are electrically coupled and grounded. At step 735, a first layer of material is deposited onto the build plate, forming the interaction zone and interface between the witness coupon and the build plate. At step 740, additional sequential layers of material are deposited, representative of the process parameters of the part, or part features, the coupon represents such as, heat input, deposition rate, and cooling. At step 745, the coupon is cooled and concurrently manufactured layer by layer with the part it represents. In numerous embodiments, the coupon is cooled via a cooling apparatus in connection with the build plate, part, and/or fixture. The cooling apparatus can cool the fixture and/or the part during the manufacture process such that the temperature of the fixture replicates the temperature of the part. In certain embodiments, the part can incorporate cooling apparatus channels to cool the part during the manufacturing process, and such channel may variously be left in the part for later use during part operation, left in the part although not for later use, or even machined off after process 700 is complete.

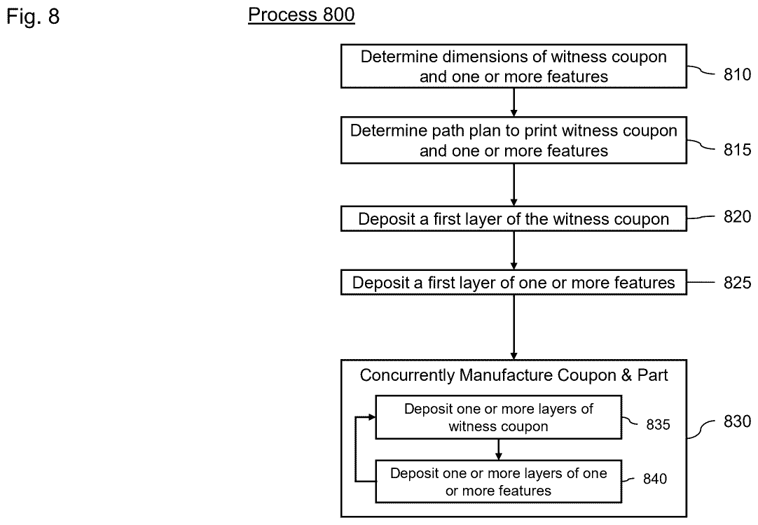

FIG. 8 depicts process 800 for path planning to additively manufacture a witness coupon and features. At step 810, the dimensions of the witness coupon and one or more features are determined. The dimensions of each feature can be different. In several embodiments, the dimensions of the witness coupon are representative of one or more features based on the testing standard and requirements of the part it represents. At step 815, the path plan to print the witness coupon and the one or more features is determined. The path plan, as described herein, relates to the order of deposition of one or more layers of material within the additive manufacturing process. The path plan can be configured to deposit material layers for different features and witness coupons concurrently, such that each feature and witness coupon is manufactured piecemeal. In some embodiments, the determined path plan can incorporate orientation changes of the part to determine the order of concurrent manufacture of one or more features and witness coupon. At step 820, a first layer of material is deposited onto the build plate according to the path plan, forming the interaction zone and interface between the witness coupon and the build plate. At step 825, a first layer of each of the one or more features is deposited according to the path plan. At step 830, the witness coupon and one or more features are concurrently manufactured according to the path plan. The path plan can direct (835) deposition of one or more layers of the witness coupon and direct (840) deposition of one or more layers of each feature to provide concurrent piecemeal manufacturing until the one or more features and witness coupon are complete.

Although specific embodiments of the invention have been described and illustrated, the invention is not to be limited to the specific forms or arrangements of parts so described and illustrated. The scope of the invention is to be defined by the claims appended hereto and their equivalents.

Although the operations of the method(s) herein are shown and described in a particular order, the order of the operations of each method may be altered so that certain operations may be performed in an inverse order or so that certain operations may be performed, at least in part, concurrently with other operations. Instructions or sub-operations of distinct operations may be implemented in an intermittent and/or alternating manner.

It should also be noted that at least some of the operations for the methods described herein may be implemented using software instructions stored on a computer usable storage medium for execution by a computer. As an example, an embodiment of a computer program product includes a computer usable storage medium to store a computer readable program.

The computer-usable or computer-readable storage medium can be an electronic, magnetic, optical, electromagnetic, infrared, or semiconductor system (or apparatus or device). Examples of non-transitory computer-usable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

The coordinated movement between the build plate and the weld torch may be as described in the following patent applications: “Control Architecture for Additive Manufacturing Robotic Systems” (U.S. patent application Ser. No. 18/791,302), “Modular Metal 3-D Printer Build Plate” (U.S. patent application Ser. No. 18/352,995), “Systems for Horizontal Additive Manufacturing and Methods Thereof” (U.S. patent application Ser. No. 18/352,992), “Additive Manufacturing Modular End Effector Assembly” (PCT Application No. PCT/US2023/076486), and “Printing Heads and Associated Methods” (U.S. patent application Ser. No. 18/330,987); These documents are hereby incorporated by reference in their entirety.

Defect and distortion identification, path distortion, and control systems are described in the following applications: “Deliberate Defect Introduction in Additive Manufacturing” (U.S. Provisional Patent Application No. 63/716,673), “Automated Defect Recognition and Determination of Pore Cluster Compliance” (U.S. patent application Ser. No. 18/929,462), “Real-Time Adaptive Control of Additive Manufacturing Processes Using Machine Learning” (U.S. patent application Ser. No. 15/604,473), “Control Architecture for Additive Manufacturing Robotic Systems” (U.S. Provisional Patent Application No. 63/552,610), “Methods and Systems for Fabrication of Three-Dimensional Objects” (U.S. patent application Ser. No. 16/683,760), and “Systems and Methods for Three-Dimensional Printing” (U.S. patent application Ser. No. 17/378,875); These documents are also incorporated by reference in their entirety.

After one or more components have been printed, defects and distortions may be identified as described above and in “Additively Manufactured Combustion Chambers, Manifold Structures and Hybrid Additive Processes Related Thereto” (U.S. application Ser. No. 18/515,033), which is hereby incorporated by reference in its entirety.

An automated additive manufacturing system may utilize an automatic feed material system as described in “Additive Manufacturing Using Multiple Metallic Materials” (U.S. patent application Ser. No. 18/607,251), which is also incorporated by reference in its entirety.

What is claimed is:

1. A method of additively manufacturing a witness coupon, the method comprising:
determining a build volume of a witness coupon;
determining an orientation of the witness coupon to replicate a property of a part;
preparing a build plate for additive manufacturing the witness coupon;
securing a fixture to an additive manufacturing system;
electrically coupling and grounding the fixture and the additive manufacturing system;
depositing a first layer of a material on the build plate;
depositing a layer of the material on the part;
depositing additional sequential layers of the material on the first layer of a material on the build plate forming the witness coupon;
manufacturing the witness coupon concurrently layer by layer with the part;
wherein the sequential layers are configured to be representative of at least one property of the concurrently manufactured part.

2. The method of claim 1 further comprising, post-processing the witness coupon to match post-processing conditions of the part.

3. The method of claim 1 further comprising, extracting at least one test sample from the witness coupon.

4. The method of claim 3 further comprising, subjecting the at least one test sample to a quality assurance test selected from the group consisting of non-destructive evaluation, destructive testing, statistical analysis to validate the additive manufacturing process.

5. The method of claim 1 wherein, the build volume of the witness coupon is configured for a testing standard.

6. The method of claim 1 wherein, wherein the at least one property is selected from the group consisting of grain structure and stress orientations.

7. The method of claim 1 wherein, depositing the first layer of the material onto the build plate forms an interaction zone of the coupons and an interface between the witness coupon and the build plate.

8. The method of claim 1 wherein, the additional sequential layers are deposited with a process parameter representative of the part the process parameter is selected from the group consisting of heat input, deposition rate, and cooling.

9. An apparatus for additively manufacturing a witness coupon, the apparatus comprising:
a fixture secured to an additive manufacturing system, the fixture being electrically coupled and grounded to the additive manufacturing system;
wherein the fixture comprises a build plate configured to support the deposition of a material for a witness coupon;
a material deposition system configured to deposit a first layer of the material onto the build plate and additional sequential layers of the material onto the first layer;
wherein the material deposition system sequentially print layers of the coupon and the part and is configured so that the layers of the coupon are representative of a property of the part; and
wherein the witness coupon and the part are manufactured concurrently.

10. The apparatus of claim 9 wherein, the property of the part is selected from the group consisting of heat input, deposition rate, cooling, grain structure and stress orientations.

11. The apparatus of claim 9 wherein, an orientation of the witness coupon is optimized for printing and configured to replicate properties of a concurrently printed part.

12. The apparatus of claim 9 wherein, the witness coupon is disposed at an electrical extremity from a grounding point.

13. The apparatus of claim 9 wherein, the fixture is configured so that the witness coupon is located proximal to the part.

14. The apparatus of claim 13 wherein, the fixture location is further configured to decrease a distance between the part and the coupon.

15. A method of additively manufacturing a witness coupon, the method comprising:
mounting a part to a build plate of an additive manufacturing system, wherein the part is mechanically coupled to the build plate and electrically coupled to the build plate;
mounting a coupon fixture to the part, wherein the coupon fixture is mechanically coupled to the part and electrically coupled to the part;
depositing, by the additive manufacturing system, a layer of a feature on the part by melting a material onto the part using an electrical current flowing through the material, the part, and the build plate; and
depositing, by the additive manufacturing system, a layer of a witness coupon on the coupon fixture by melting the material onto the coupon fixture using an electrical current flowing through the material, the coupon fixture, the part, and the build plate.

16. The method of claim 15, further comprising repeating the steps of the depositing the layer of the feature and of the depositing the layer of the witness coupon until the feature has been additively manufactured and the witness coupon has been additively manufactured.

17. The method of claim 15, further comprising cooling the witness coupon on the coupon fixture by cooling the coupon fixture using coolant flowing through the coupon fixture, the part, and the build plate.

18. The method of claim 15, further comprising:
mounting a second coupon fixture to the build plate, wherein the second coupon fixture is mechanically coupled to the build plate and electrically coupled to the build plate; and
depositing, by the additive manufacturing system, a layer of a second witness coupon on the second coupon fixture by melting the material onto the second coupon fixture using an electrical current flowing through the material, the second coupon fixture, and the build plate.

19. The method of claim 15, further comprising:
mounting a second coupon fixture to an external support, wherein the second coupon fixture is mechanically coupled to the external support; and
depositing, by the additive manufacturing system, a layer of a second witness coupon on the second coupon fixture by melting the material onto the second coupon fixture using an electrical current flowing through the material and the second coupon fixture.

20. The method of claim 15, further comprising:
depositing, by the additive manufacturing system, a layer of a second witness coupon on the build plate by melting the material onto the build plate using an electrical current flowing through the material and the build plate.
